(19) United States
(12) Patent Application Publication
(10) Pub. No.: US 2015/0193737 A1
(43) Pub. Date: Jul. 9, 2015

(54) Compensation Optimization Systems And Methods

(71) Applicant: Mercer (US) Inc.,, New York, NY (US)

(72) Inventors: Abhishek Jadia, Haryana (IN); Bhupesh Vats, New Delhi (IN); Mohit Mehra, Haryana (IN)

(21) Appl. No.: 14/592,119

(22) Filed: Jan. 8, 2015

Related U.S. Application Data
(60) Provisional application No. 61/925,116, filed on Jan. 8, 2014.

(51) Int. Cl. G06Q 10/10; G06Q 50/18; G06F 17/30

(52) U.S. Cl. CPC G06Q 10/1053; G06F 17/30557; G06Q 50/188

(57) ABSTRACT

A system for optimizing a candidate compensation offer for a position within an organization that includes a compensation optimization engine capable of using candidate information and internal organization information about a position to objectively analyze the candidate and organization information against candidate and organizational constituencies to generate a user interface tool that enables organization personnel to create an objective offer based on the candidate's value to the organization via the position.

This application claims priority to U.S. provisional application 61/925,116, filed Jan. 8, 2014. U.S. provisional application 61/925,116 and all other extrinsic references contained herein are incorporated by reference in their entirety.

### FIELD OF THE INVENTION

The field of the invention is the generation of custom user interfaces for candidate management and acquisition.

### BACKGROUND

The background description includes information that may be useful in understanding the present invention. It is not an admission that any of the information provided herein is prior art or relevant to the presently claimed invention, or that any publication specifically or implicitly referenced is prior art.

Human resources and talent acquisition teams face many challenges when recruiting potential members for their organizations. For some organizations, talent acquisition teams have to recruit, evaluate and ultimately make offers to a large number of prospective employees or members, often across a multitude of personnel categories, organizational departments (e.g. IT services, client services, retirement, finance and accounting, etc.), skill types and grades. Additionally, organizations often have mandatory approval processes that must be followed for each compensation offer to a prospective employee. Further, the recruitment and compensation offer process can often suffer due to the subjectivity of the personnel handling each individual case within a talent acquisition. Thus, talent acquisition remains a difficult process for organizations to perform accurately and efficiently.

Others have put forth efforts towards improving an organization's talent recruitment. For example, U.S. Pat. No. 7,797,181 to Vianello, issued on Sep. 14, 2010, is generally directed to career employment services. Vianello discusses matching salary requirements for a candidate with the available compensation as determined by an employer. Vianello also discusses searching candidates and presenting search results in order according to a scoring system. U.S. pre-grant publication number 2002/0055870 to Thomas, published May 9, 2002 is generally directed to matching profile parameters to measure job candidates. Thomas discusses candidate filtering and scoring for matching to a job according to parameters. U.S. pre-grant publication number 2006/0212338 to Bogle, et al, published Sep. 21, 2006 is generally directed to identifying candidates for a position. Bogle discusses ranking candidates based on referral ratings including weights based on degrees, and scoring candidates using the weights.

All of these attempts focus on candidate identification and filtering, and lack any discussion regarding assessing and optimizing a candidate according to their value brought to an organization and enabling an organization to be able to present an offer to a candidate that is harmonized and optimized according to the organizations internal and external concerns. Further, none of the existing solutions provide for the generation of an interface for an organization to use that is unique to each candidate according to the optimization of each individual candidate for an organization.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for a customized user interface that presents individual candidates according to the optimized internal and external concerns of an organization, and enables the organization to take action on the each candidate.

### SUMMARY OF THE INVENTION

The inventive subject matter provides apparatus, systems and methods in which an organization can optimize an offer to a candidate via a customized user offer tool uniquely generated for each candidate. The offer is the result of optimization across three constituencies: the individual candidate, a variation from a population median internal to the organization, and a wage optimization relative to a budgeted cost.

The inventive subject matter can include a compensation optimization engine that can receive position attributes (such as in a position object) associated with a position within an organization and candidate information including candidate attributes associated with a candidate.

The compensation optimization engine can apply a weight scheme to one or more of the candidate attributes and generate a value-brought object associated with the candidate having value-brought attributes including a candidate's compensation as value brought attribute that corresponds to the value the candidate brings to the position from an organizational perspective.

The compensation optimization engine can generate a value brought optimization object as a function of at least one value brought attribute from the value brought object and each of at least one candidate attribute, at least one first position attribute, and at least one second position attribute. The value-brought optimization object corresponds to an analysis of the offer with regard to the value brought by the candidate and includes a first, second and third value attributes associated with each constituency.

The compensation optimization engine can also generate a variation optimization object as a function of the at least one first position attribute and each of the at least one candidate attribute, and the at least one second position attribute. The variation optimization object is concerned with an analysis to minimize variation, and includes a first, second and third variation attributes associated with each constituency.

The compensation optimization engine can generate a final optimization object by using a spectrum algorithm, as a function of the at least one candidate attribute, the at least one first position attribute, and the at least one second position attribute. The variation optimization object is concerned with an analysis to provide a range and/or possible maximum value for an offer, and includes a first, second and third spectrum attributes associated with each constituency.

Having the value brought optimization object, variation optimization object and final optimization object, the compensation engine can generate a custom user offer tool unique to that candidate that an organization's personnel (e.g., recruiting team, human resources personnel, etc.) can use to modify and decide on an offer within an acceptable, objective range without permitting the user to go outside of the range. In embodiments, the user can select an offer value using the user offer tool and export the value to generate an offer letter to email and/or print for presentation to the candidate.

In embodiments, the compensation optimization engine can derive an optimized offer as a function of the value brought optimization object, the variation optimization object, and the final optimization object and generate an optimized compensation recommendation based on the optimized offer. Having generated the optimized compensation recommendation, the compensation optimization engine causes an output device to present the optimized compensation recommendation to a user.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an overview of a system according to the inventive subject matter.

FIG. 1A is a detailed view of an example position object.

FIG. 2 is a flowchart providing an overview of the functions and processes of the inventive subject matter executed by the compensation optimization engine.

FIG. 3 is a detailed view of an example candidate information object.

FIG. 4 provides a detailed view of the processes of step 210 from FIG. 2 executed by the compensation optimization engine.

FIG. 5 provides a detailed view of an example value brought object.

FIG. 6 provides a detailed view of the application of ratings and weights to candidate attributes and the generation of a weighted score attribute and a total value brought attribute by the compensation optimization engine.

FIG. 7 shows the generation of the value brought optimization object by the compensation optimization engine.

FIG. 8 shows the generation of the variation optimization object by the compensation optimization engine.

FIG. 9 illustrates the processes and functions of the spectrum algorithm when executed by the compensation optimization engine.

FIG. 10 shows the generation of the final optimization object by the compensation optimization engine.

FIG. 11 is an example of a customized user offer tool generated by the compensation optimization engine.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

One should appreciate that the disclosed techniques provide many advantageous technical effects including generating a custom interface for use by an organization's recruiting teams for each prospective candidate that restricts the organization personnel's ability to manipulate the offer, ensuring objectivity in the offer process. Restricting a human operator's decision making eliminates the risk that subjective factors in the offer process by individuals will lead to erroneous, inconsistent or even discriminatory practices.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used herein, an organization can refer to a company, business, employer, or other organization having members (e.g., employees, ranked members) having positions associated with the purpose of the organization (e.g., employment positions).

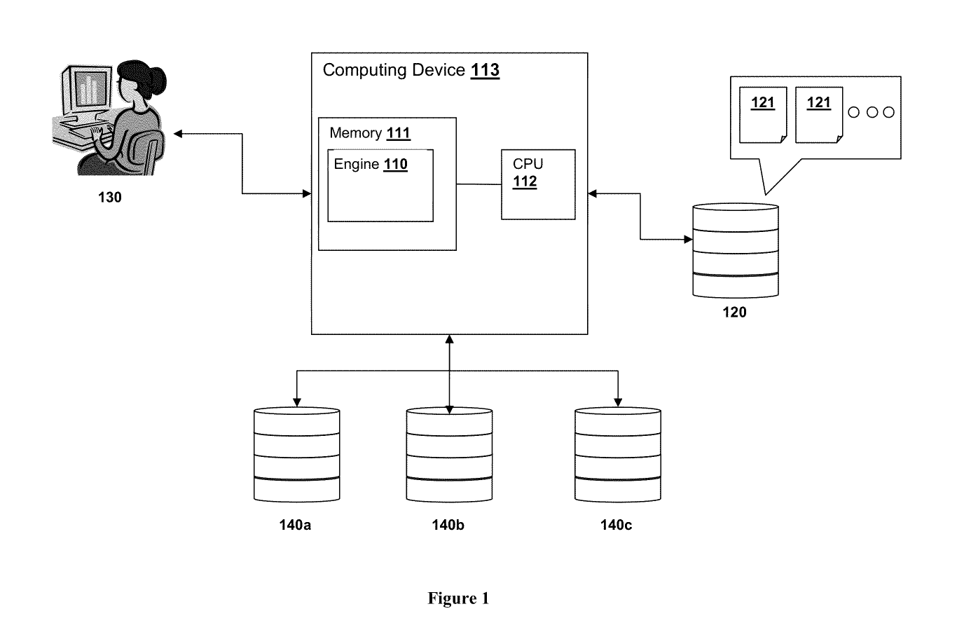

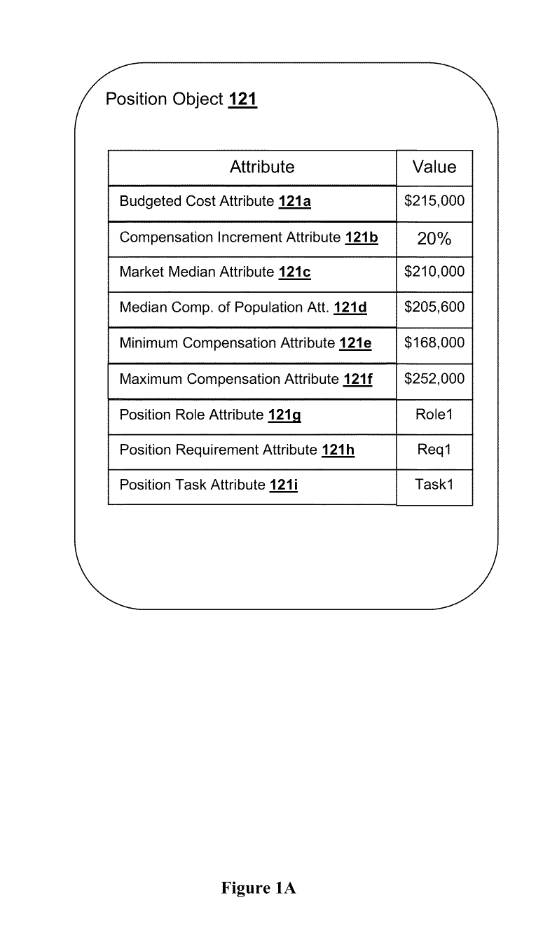

FIG. 1 provides an overview of an example system of the inventive subject matter.

As shown in FIG. 1, system 100 can include a compensation optimization engine 110, a position database 120, a user interface 130, and one or more organization database(s) 140. The organization databases 140 can include a candidate database 140a, weight database 140b, a rating database 140c, and other databases internal to or under the control of the organization. In embodiments, all of the organizational databases 140 can be a single database (housed on one or more non-transitory computer readable storage media such as hard drives, servers, optical media, etc.), or one or more separate databases (housed on one or more separately located non-transitory computer readable storage media such as hard drives, servers, optical media, etc.) remotely located from each other and accessible by the compensation optimization engine 110, the user interface 130, and other components of system 100 as necessary. In embodiments, the position database 120 and one or more of the organization databases 140 can be combined into a single database or can exist separately as databases logically and/or physically separate from each other.

In embodiments, the compensation optimization engine 110 can be embodied as computer-executable instructions stored on a non-transitory computer-readable storage medium 111 (e.g., RAM, ROM, hard drive, solid-state drive, etc.) that are executed by a processor 112 to execute functions and processes associated with the inventive subject matter. As shown in FIG. 1, the compensation optimization engine 110 and processor 112 are internal to computing device 113. Examples of suitable computing devices 113 include a server computer, a desktop computer, a laptop computer, a smartphone, a tablet, etc. It should be noted that the memory 111 (storing compensation optimization engine 110) can be local to compensation optimization engine 110 and/or processor 112 or remotely located from processor 112 and/or compensation optimization engine 110.

Position database 120 is configured to store position objects to be accessed by the compensation optimization engine in executing functions and processes associated with the inventive subject matter. The position database 120 can be in the form of one or more non-transitory computer readable storage media (e.g., RAM, ROM, optical media, solid-state drives, flash memory, etc.) that is configured to store the position objects 121.

A position object 121 can be considered to be a data object representative of a particular employment position within an organization. A position object 121 can have one or more position attributes representative of the characteristics and information about the employment position. The position attributes can be based on the organization's own information, making the position objects reflective of the organization's subjective view of the employment position. Examples of position attributes include a compensation increment attribute, position requirement attributes, population value attributes, a position role attribute, a position task attribute, a position skill attribute, a minimum offer attribute, a maximum offer attribute, a median compensation of an existing population attribute, a market median attribute, and a budgeted cost attribute.

FIG. 1A provides an illustrative view of an example of a position object 121 illustrating some of the position attributes in greater detail.

The budgeted cost attribute 121a corresponds to the total budget for the position as determined by the organization. This can be considered to be the highest amount that the organization is willing or able to spend on filling a particular position. In embodiments, the budgeted cost attribute can be set at 20% greater than the market median attribute. Thus, if the market median changes due to market forces, the budgeted cost attribute will be similarly updated to reflect the changes.

The compensation increment attribute 121b is the maximum increase from a current compensation that an organization will offer, as a percentage value or decimal value. Thus, in an illustrative example, the compensation increment attribute can be set at 20%. The incorporation of the compensation increment attribute into the functions and processes of the inventive subject matter will be discussed in greater detail below.

The market median attribute 121c corresponds to a market median value for the position. The market median value can be obtained via industry surveys or survey services that collect and provide statistical industry information.

The median compensation of an existing population attribute 121d corresponds to the median compensation of a group of organization members internal to the organization. This group can be a cross-sectional group of employees selected by the organization, a department within the organization, a team, all employees of a particular position, all employees of a particular experience level, etc. Associated with the median compensation of an existing population attribute 121d can be a population values attribute (not shown) that identifies the population. The population values attribute can include information such as the number of employees, identification of the position within the organization (for the group, or for employees individually), identification of the group, team or department that is represented by the “existing population” grouping, individual identification of the employees within the “existing population” grouping, etc.

The minimum compensation attribute 121e corresponds to the minimum amount that the organization will offer for that position. This can be set by the organization. In embodiments, the minimum compensation attribute 121e can correspond to an amount a certain percentage below the market median, the existing population median, the lowest-earning employee within the existing population, etc.

The maximum compensation attribute 121f corresponds to the maximum offer the organization is capable (or willing) to offer a candidate for the position represented by position object 121. The maximum compensation attribute 121f can correspond to an increase over the market median attribute 121c or the population median 121d, and thus can change depending on changes to the market median attribute 121c or the population median attribute 121d. In this example, the maximum compensation attribute of position object 121 corresponds to a 20% increase over the market median attribute 121c of the position object 121, and thus the value calculated as a part of the regular updates to the position object 121 within the position database 120. Thus, in this example, the maximum compensation attribute 121f is $252,000. In embodiments, the maximum compensation attribute 121f can be equal to the budgeted cost attribute 121a.

The position role attribute 121f corresponds to the role of the position within the organization, which can include a title and position within the organization hierarchy. The position requirement attribute 121g can correspond to the requirements for a candidate for consideration, such as years of experience, degrees, etc. This information is typically used in the screening process when setting up interviews with candidates, prior to the execution of the functions and processes of the inventive subject matter. The position task attribute 121h corresponds to the tasks and responsibilities associated with the position that have to be performed by a candidate ultimately hired to fill the position. The position skill attribute (not shown) corresponds to a level of skill demanded by the position relative to other positions within the organization. This can be set to a set of levels, such as “low”, “medium” and “high.”

Beyond these position attributes, the position object 121 can also include a position identifier (not shown) that identifies the specific position within the organization to which the position object 121 applies. Other information that can be included in the position object 121 can be an identifier of the member of the organization that caused the position object 121 to be generated (e.g., by entering the appropriate information into via the user interface 130), an expiration date for the position object 121 (upon which the system can automatically delete the position object 121 as being no longer relevant), etc.

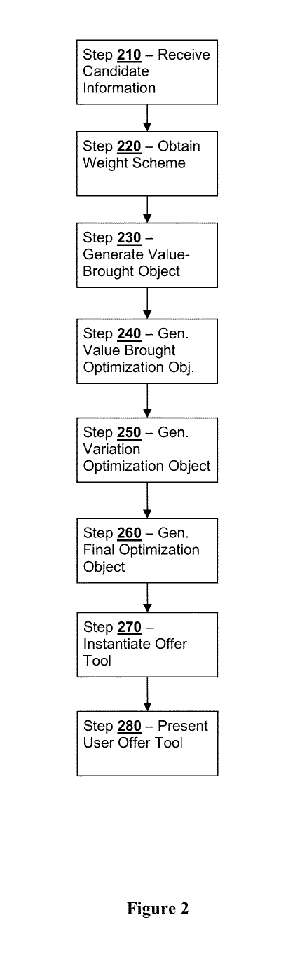

FIG. 2 provides an illustrative example of the functions and processes executed by compensation optimization engine 110.

At step 210, the compensation optimization engine 110 receives candidate information that includes a plurality of candidate attributes associated with a candidate. The candidate information can be received from a candidate database managed by the organization that includes information associated with the candidate gathered from resumes, interviews, written assessments, and other types of evaluations. These can be manually entered by members of the organization into the candidate database.

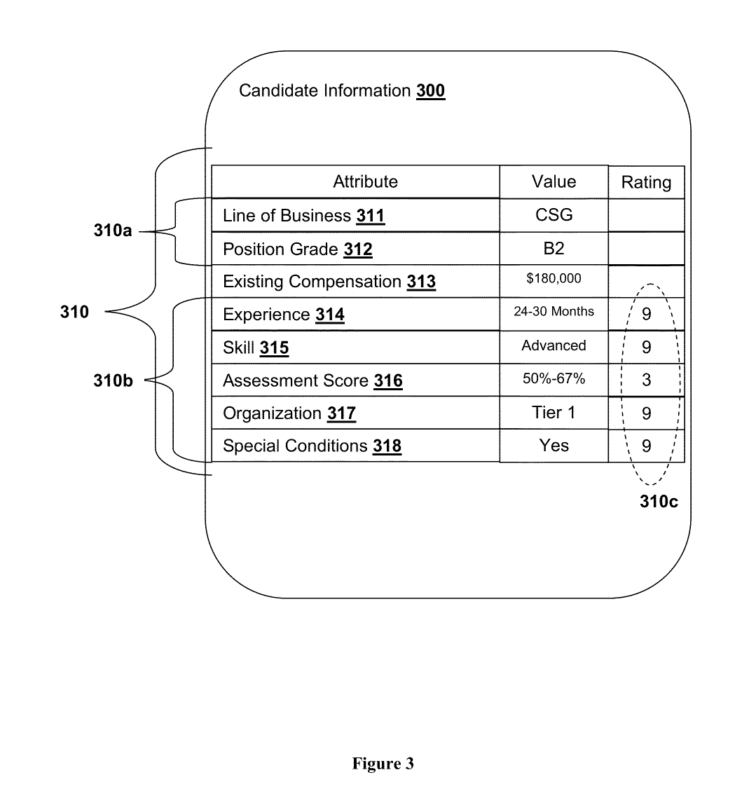

FIG. 3 provides an illustrative example of the candidate information 300 received by the compensation optimization engine 110 corresponding to a particular candidate, including candidate attributes 310. The candidate information 300 can be in the form of a data object having candidate attributes 310 with associated candidate attribute values. Contemplated candidate attributes include a line of business attribute 311, a position grade attribute 312, an existing compensation attribute 313, a prior experience attribute 314, one or more skill attribute(s) 315, an assessment score attribute 316, a previous organization attribute 317, and a special conditions attribute 318.

The line of business attribute 311 represents the career field or industry of the applicant. The value of the line of business attribute can be a code or identifier for the particular industry according to a predetermined namespace used by the organization. The line of business attribute can also serve as an identifier of the department, group, or position category for which the candidate is being considered (as matched during the resume screening and/or interview processes occurring during the recruitment of a candidate, prior to the involvement of the functions and processes of the inventive subject matter). In the example of FIG. 3, the “CSG” value for line of business attribute 311 corresponds to the “client service group” line of business.

The position grade attribute 312 represents the level of the position offered (that the candidate is being considered for), according to an organization's tiered or hierarchical categorization. For example, an organization can have levels of “entry level” (low), “mid-level” (medium) and “senior-level” (high) for a position. The organization can have additional levels representing more granular gradients of candidate categorization. Other position grade attributes can be reflective of special categorization or title of a candidate, such as “management”, “partner”, “specialist”, etc. In embodiments, the various categorization levels of a position grade attribute can correspond solely to the amount of experience (e.g., years of experience, projects or other position-related tasks completed, etc.) required for each level. In embodiments, the position grade attribute levels can be determined based on a desired combination of experience, skills, certifications, education level, and other criteria. In the example of FIG. 3, the position grade “B2” is assumed to correspond to a “mid-level” position (with “B1” corresponding to “entry level” and “B3” corresponding to a “senior level” position).

The line of business attribute 311 and position grade attribute 312 can be considered to be “identification attributes” (collectively 310a) as they are used by the compensation optimization engine 110 to determine certain aspects of how the candidate analysis is conducted, as is described in further detail below.

The existing compensation attribute 313 corresponds to the candidate's current (or most recent) compensation. The existing compensation attribute 313 can be expressed in values representing hourly compensation, annual compensation, with or without bonuses, with or without benefits, with or without cost-of-living adjustment, etc. In the example of FIG. 3, the candidate's existing compensation is shown as having a value of “$180,000”.

For the sake of convenience, the experience attribute 314, skill attribute 315, assessment score attribute 316, organization attribute 317 and special conditions attribute 318 can collectively be referred to as “criteria attributes” 310b. The criteria attributes 310b can each have attribute values according to levels of pre-defined ranges within a hierarchy of levels, within which the candidate's particular measured or determined attribute falls. In embodiments, the number of levels can be uniform across all of the criteria attribute 310b (e.g., each of the criteria attributes 310b has 3 different levels, 5 levels, etc.). In other embodiments, each of the criteria attributes 310b can have different number of levels as determined by the organization. In embodiments, one or more of the criteria attributes 310b can have values corresponding to the candidate's determined or measured quantity instead of a range within which the candidate's value falls (e.g., actual years of experience instead of a range within which the candidate's years of experience falls).

As shown in FIG. 3, criteria attributes 310b can be associated with ratings (collectively, 310c). The ratings 310c are used to represent the criteria attribute values (and their relative degrees) in a common nomenclature for the purposes of determining the candidate's value brought. The rating values are all within a defined range of possible rating values (in the example of FIG. 3, it is assumed that ratings 310c can be within the range of 0-10). For each of the criteria attributes 310b, a rating value can be correlated to an attribute value level or step in a hierarchy or can be made proportional to possible criteria attribute values for the particular criteria attribute. For example, if an attribute has three possible values (low, medium, high), then the ratings assigned to the values for that attribute can be 1, 5, and 10 (or 1, 3, 9) respectively. For attributes having greater number of levels (e.g., 5 possible values), the ratings can be distributed as such (e.g., ratings of 1, 3, 5, 7, 9 or 2, 4, 6, 8, 10). It is further contemplated that the “10” rating can be reserved for a “perfect” attribute value (i.e., the highest attribute value possible or level possible for that attribute) and levels below this “perfect” level be assigned numbers between 1-9. Additionally, because ratings are used to account each of the criteria attributes in calculating the candidate's value brought (as described in further detail below), the rating of “0” can be assigned to effectively nullify an attribute whose level is deemed too low to warrant consideration.

In another example, if an attribute can have values that can be expressed as numbers (e.g., percentages or other quantified amounts), then the rating values can correspond to the possible ranges of attribute values directly or according to predefined functions. The rating values can be whole numbers or include decimal values as well.

The ratings for criteria attributes 310b can be stored in a ratings database, indexed according to the criteria attribute name and value, and retrieved by the compensation optimization engine 110 after receiving the candidate information 300. For the example in FIG. 3, the ratings for each of the criteria attributes 310b is further described within each individual attribute description.

The experience attribute 314 corresponds to a quantitative measure of the candidate's experience level in the field or industry. This can be expressed as a time frame (e.g. years in industry) or by measurable work completed (e.g., projects completed, achievements, milestones, etc.). In the example of FIG. 3, the experience attribute 314 is shown having a value of “24-30 Months” and a corresponding rating of “9”. For this example, it is assumed that the experience attribute has five possible value levels, from lowest to highest: “0-6 Months” (with a corresponding rating of “1”), “6-12 Months” (rating of “3”), “12-24 Months” (rating of “6”), “24-30 Months” (rating of “9”) and “30+ Months” (with rating of “10” as the highest rated value for the highest tier or level of experience). In alternative embodiments, the value of experience attribute 314 can be a number value that represents the actual experience (e.g., the value as 18 months, 13 months, 27 months, etc.), and can be proportionally correlated to the ratings from 1-10 (including decimal values) where a “10” rating corresponds to the highest experience level in terms of time that the organization considers a quantifiable difference (i.e., beyond that time frame, the experience level doesn't matter for compensation purposes).

The skill attribute 315 corresponds to the level of the candidate's relevant skills. This can be based on the skills provided by the candidate on a resume, during an interview, etc. These skills can include technical skills (e.g., skills with certain software programs, knowledge of certain programming languages, etc.) and other skills that are relevant to the position (e.g., foreign language skills, etc.). The skill attribute can be a level-based attribute reflecting the candidate's level of skill. For example, a skill attribute can be one of “novice”, “intermediate”, “advanced” and “expert.” In embodiments, the skill attribute can be provided by an organization's member (such as the member responsible for or otherwise involved in the candidate hiring process). In other embodiments, the compensation optimization engine 110 can match the skills listed on a candidate's resume to a set of desired skills represented by position requirement attributes of the position object (which can include required skills, education level, professional awards and recognition, accomplishments, etc.) for a position and determine the skill level based on the amount of matching skills. For example, an “expert” level can correspond to a match of 100% of the desired skills held by the candidate, an “advanced” level can correspond to a match within the range of 75%-99%, an “intermediate” level as being between 25%-74% and a “novice” as being under 24%. In the example of FIG. 3, the experience attribute 314 illustrates a value of “advanced” (having a rating of “9”) from four possible levels, from highest to lowest: “expert” (corresponding to a rating of “10”), “advanced” (rating of “9”), “intermediate” (rating of “3”) and “novice” (rating of “1”).

The assessment score attribute 316 is a score value based on a written assessment of the candidate, where a candidate answers a series of evaluation questions related to their experience, achievements, hypothetical job situations, or other evaluation questions. The written assessment can be graded or otherwise evaluated by the appropriate personnel in the organization and/or automated (such as via a multiple choice test graded by the compensation optimization engine 110 against pre-defined answers) to determine the assessment score attribute. It should be noted that the assessment score is an objective evaluation such that the evaluation of the written assessment is performed against pre-determined answers such that there is no room for subjective interpretation or evaluation by a human evaluator. The assessment score attribute can be expressed as a percentage, a numerical score, a grade level (e.g., as within an upper and lower range of several tiered ranges of scores), or other scoring criteria.

In embodiments, the compensation optimization engine 110 can be programmed to automatically review assessment scores 316 as soon as the candidate information 300 is received to filter out any candidates who fall below a threshold for the written assessment. For example, any scores falling within the 0%-39% range (i.e., less than 40%) can be automatically filtered out. In other embodiments, candidates who score lower than the threshold are filtered out prior to the compensation optimization engine's receipt of the candidate information 300 for analysis and optimization. Thus, if the candidate optimization engine 110 detects an assessment score attribute value lower than the threshold, it can flag the candidate information 300 as an error and report the same to the organization via the user interface 130.

In the example of FIG. 3, the assessment score attribute 316 is illustrated as “50%-67%”, indicating that the candidate's score fell within this range (for example, a score of 60%). In this example, the levels for assessment score attribute values are, from lowest to highest: 0%-39%, 40%-49%, 50%-67%, 68%-85% and 86%-99% and 100%. For this example, it is assumed that an assessment score attribute value falling in the “0%-39%” range is considered to be an error and is reported as such via the user interface 130. In this example, for and assessment score attribute 316 of 40%-49% the corresponding rating is “1”; for 50%-67%, the rating is “3”; for “68%-85%”, the rating is “6”, for “86%-99% the rating is “9” and for “100%” the rating is “10.” In the example of FIG. 3, the rating of the assessment score attribute 316 is “3” because the assessment score value corresponds to the “50-67%” level.

The organization attribute 317 represents the level or rating of the candidate's previous organization (e.g. current or most recent employer) according to a hierarchical or tiered rating scheme reflecting the similarity of the candidate's previous organization to the organization performing the candidate analysis. The similarity can be according to an organization's internal categorization, according to recognized industry or market categorizations, according to governmental categorizations, etc. The values can be tiered, with a Tier 1 being the highest level (and thus having the “9” rating), and subsequent Tiers having lower ratings. It is contemplated that a candidate who previously worked at the organization performing the analysis could have a “Tier 0” value with rating of “10” (because the candidate worked for the organization itself, and thus has had very relevant experience with regard to familiarity with the organization).

The special conditions attribute 318 is an attribute that can be associated with special requirements or skills associated with the position that a candidate may or may not possess. For example, a position can require working night shifts, a proficiency with a particular software package (e.g., a word processing program, spreadsheet program, calendar program, design program, etc.), a foreign language proficiency, etc. In embodiments, this attribute can have a binary value corresponding to “yes” or “no”, depending on whether or not the candidate possesses the skill or condition denoted by the special attribute. In the example of FIG. 3, the special conditions attribute 318 is a binary (i.e., “yes” or “no”) attribute, with a “yes” having a rating of “9”. In this case, the “No” value is considered to correspond to a rating of “1”. In embodiments, a “No” value can be a rating of “0” so that a candidate lacking a special condition represented by the special conditions attribute 318 does not have this attribute contribute to the value brought calculation at all.

In other embodiments, the special attribute can have numerical or percentage values on a scale (e.g., 0-10, 0%-100%, levels in 20% increments, etc.) associated with a level or degree of proficiency or expertise in the special skill sought.

It should be noted that a particular position may not require any special conditions or requirements and, as such, the candidate information will not include a special conditions attribute 318. Conversely, a position can have more than one special condition or requirement, and as such the candidate information 300 can include more than one special conditions attribute (corresponding to each requirement).

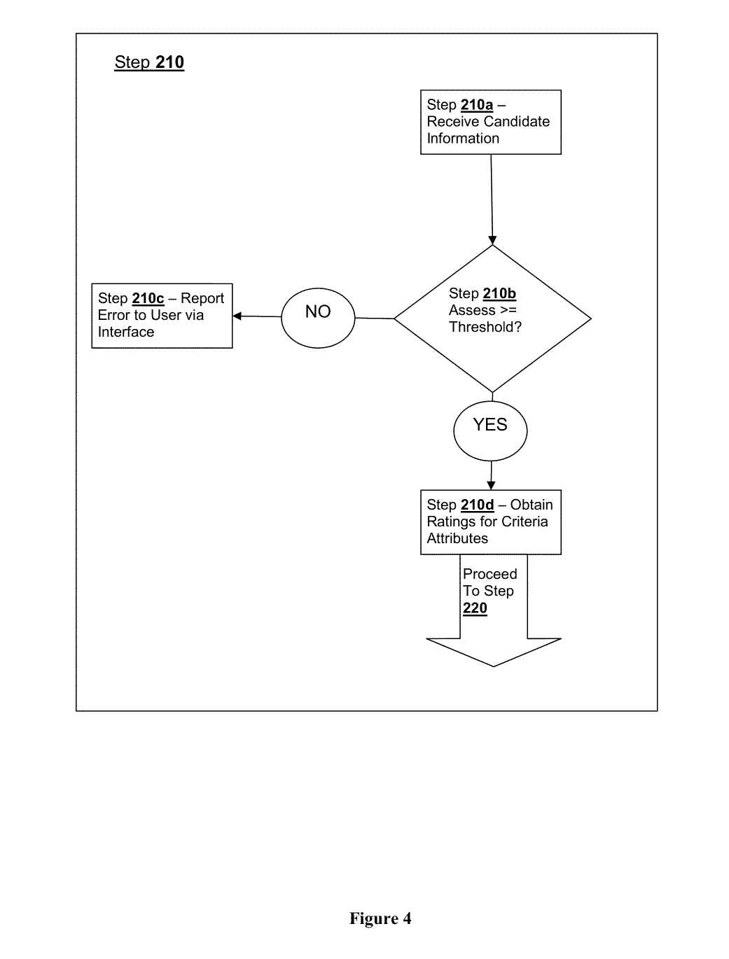

FIG. 4 provides a flowchart illustrating the processes of step 210 in greater detail, according to embodiments of the inventive subject matter. At step 210a, the compensation optimization engine 110 receives the candidate information 300 from a candidate database.

At step 210b, the compensation optimization engine 110 evaluates the assessment score attribute 316 to determine whether its value falls below the organization's pre-determined threshold for candidate consideration. In the current example, whether the assessment score attribute 316 has a value of “0%-39%”.

If the assessment score attribute 316 has a value falling below the threshold, the compensation optimization engine 110 flags the candidate information 300 as having erroneously been approved for compensation offer optimization and provides a message indicating this to the user interface 130 for presentation to the appropriate organization personnel at step 210c. As part of step 210c, the compensation optimization engine 110 stops further processing on candidate information 300 and can optionally delete candidate information 300 from its memory.

If the assessment score attribute 316 passes the threshold, the compensation optimization engine 110 then proceeds to obtain ratings from the ratings database 140c for each of the criteria attributes 310b based on their respective attribute values at step 210d. Having obtained the ratings for each of the criteria attributes 310b, the compensation optimization engine 110 proceeds to step 220 in FIG. 2.

At step 220, the compensation optimization engine 110 obtains a weight scheme from the weight database 140b. The weight scheme is a set of weight factors to be applied to one or more of the criteria attributes 310b, reflecting the relative importance of each of the criteria attributes with respect to the value brought calculation. The weight database can contain a plurality of pre-defined weight schemes suitable for different potential candidates under various circumstances. For example, the weight schemes can be indexed and/or categorized according to the values of one or more lines of business, one or more position grades or both. The indexing of the weight scheme is representative of the characteristics of the weights included in the weight scheme to be applied to the criteria attributes 310b. For example, if a weight scheme is indexed according to a position grade of “entry level”, the weights within the weight scheme will be those that give greater weight to the criteria attributes 310b most desirable or common to an entry level position. For example, the experience attribute 314 can be given a relatively low weight whereas a skill attribute 315 be given a relatively higher weight, reflecting that for an entry-level position an organization considers actual experience less important (because the organization expects to train the entry-level employees on its own and they are expected to be relatively “green”) and skills more important (because they might reflect an ability for an individual to learn and adapt). The weights within a weight scheme can be expressed as percentages or decimal values. In preferred embodiments, the total weights of the weight scheme must add up to 100% (if percentages) or 1.0 (if decimal values).

In embodiments, a weight scheme can be defined such that the weight corresponding to assessment score attribute 316 must be given a greater weight than any of the other attributes. In a variation, a weight scheme can be defined such that the assessment score attribute 316 must be given a weight of at least 40%.

As such, the compensation optimization engine 110 can obtain a weight scheme from the weight database 140b based on the line of business attribute 311 and/or the position grade attribute 312 according to the indexed weight schemes by matching the business attribute value and/or position grade attribute value of the candidate information 300 with the corresponding business line value and/or position grade value associated with the weight schemes in the weight database. In embodiments, if a weight scheme is indexed using both a business line value and a position grade value, to obtain a match, at least one of the value of the business line attribute 311 and the value of the position grade attribute 312 must match those of the a weight scheme. In other embodiments, both the value of the business line attribute 311 and the value of the position grade attribute 312 must match those of the weight scheme.

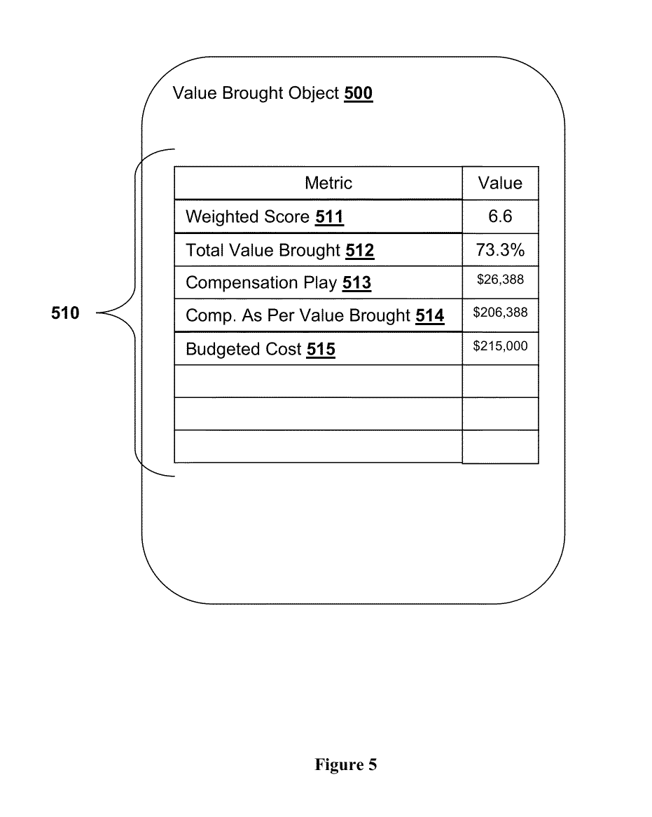

At step 230, the compensation optimization engine 110 uses the candidate attributes 310 to generate a value-brought object having value-brought attributes. FIG. 5 provides an illustrative example of a value brought object 500 having value-brought attributes 510. The value-brought attributes 510 can include one or more of a weighted candidate score attribute 511, a total value brought attribute 512, a compensation play attribute 513, a compensation as value brought attribute 514, and a budgeted cost attribute 515. The budgeted cost attribute 515 can be obtained from the position attributes, as it is indicative of the budget that the organization is allocating to the position.

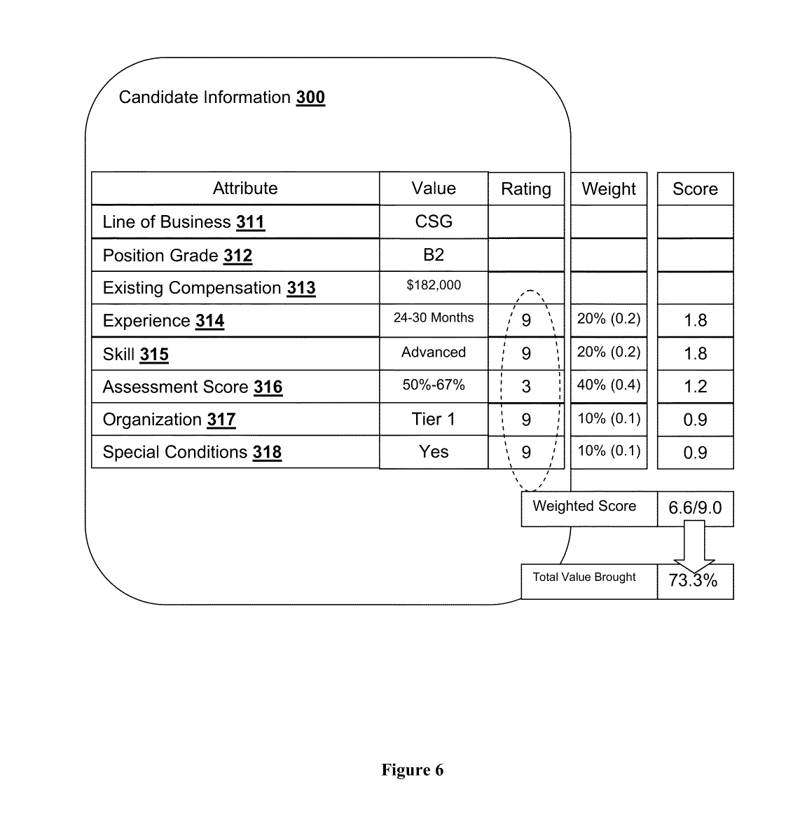

FIG. 4 illustrates step 230 in greater detail. At step 230a, the compensation optimization engine 110 applies the weight scheme to the criteria attributes 310b of the candidate information 300. As shown in FIG. 6, the weight scheme applied to the candidate information 300 of FIG. 3 includes a weight of 20% to the experience attribute 314, a weight of 20% to the skill attribute 315, a weight of 40% to the assessment score attribute 316, a weight of 10% to the organization attribute 317 and a weight of 10% to the special conditions attribute 318.

At step 230b, the compensation optimization engine 110 calculates a score for each of the criteria attributes 310b as a function of the respective rating values and weights. In the example of FIG. 5, the score for each of the attributes 310b is determined by multiplying the rating value times the weight.

At step 230c, the scores of the criteria attributes 310b are aggregated to determine the candidate weighted score 511 and total value brought 512 of value brought object 500. The total value brought 512 corresponds to the ratio of the weighted score out of a total possible score expressed as a percentage a percentage. In this example, the value of the candidate weighted score attribute 511 is 6.6 and the value of total value brought attribute 512 is 73.3%.

In embodiments, the weighted candidate score attribute 511 must be derived as a function of the assessment score attribute 316 and at least one additional candidate attribute. Thus, the candidate information 300 must have the assessment score attribute 316 and at least one other criteria attribute 310b, otherwise it will return an error to the user interface 130.

At step 230d, the compensation optimization engine 110 calculates the compensation play attribute 513 and the compensation as per value brought attribute 514. The compensation play attribute 513 can be calculated based on the existing compensation attribute 313, the compensation increment attribute (of the position object corresponding to the position) and the total value brought attribute 512. In the current example, the existing compensation attribute 313 is $180,000, the compensation increment attribute is 20% and the total value brought attribute 512 is 73.3%.

To calculate the compensation play attribute 513, the compensation optimization engine 110 first calculates 20% (the compensation increment attribute) of $180,000 (the existing compensation attribute 313) to determine a maximum compensation play of $36,000. The compensation play attribute 513 is determined by applying the total value brought attribute 512 to the derived maximum compensation play; in this example, 73.3% of $36,000 resulting in a compensation play attribute 513 of $26,388. The compensation as per value brought 514 is then determined by adding the compensation play attribute 513 to the existing compensation attribute 313.

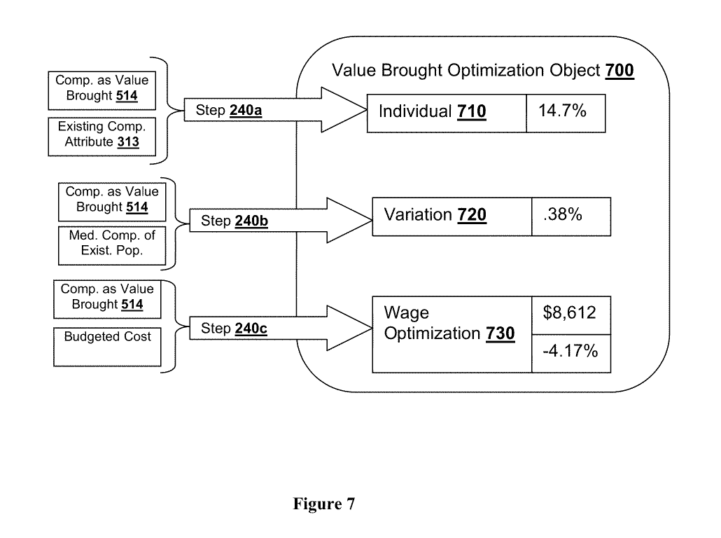

At step 240, the compensation optimization engine 110 generates a value brought optimization data object as a function of at least one of the value-brought attributes of the generated value-brought object, at least one of the candidate attributes, and at least two of the position attributes (i.e., at least a first position attribute and a second position attribute that are different from one another). FIG. 7 illustrates an example of a value brought optimization object 700, which can include a first value attribute 710, a second value attribute 720 and a third value attribute 730. The first value attribute 710 corresponds to a first constituency, the second value attribute 720 corresponds to a second constituency and the third value attribute 730 corresponds to a third constituency. The first constituency is considered to be the candidate, the second constituency is considered to be a variation from a population internal to the organization (e.g., a department, team, population of the same position within the organization, etc. to which the candidate is being compared), and the third constituency is a wage optimization constituency (i.e., concerned with optimizing wages across a department, organization, etc.).

In preferred embodiments, the value-brought attribute used at step 240 is the compensation as value brought attribute 514, the candidate attribute is the existing compensation attribute 313 and the two position attributes are the median compensation of an existing population attribute and the budgeted cost attribute (which is also the budgeted cost attribute 516 of the value-brought object 500).

FIG. 7 provides an illustrative view of the processes of step 240 in greater detail. At step 240a, the compensation optimization engine 110 derives the first value attribute 710 based on one or more value brought attributes (in preferred embodiments, and illustrated in this example, the compensation as value brought attribute 514) and the candidate attributes (in this example, the existing compensation attribute 313). The first value attribute corresponds to a percentage difference between the compensation as value brought attribute 514 and the existing compensation attribute 313.

At step 240b, the compensation optimization engine 110 derives the second value attribute based on the value-brought attribute (in this example, the compensation as value brought attribute 514) and the first position attribute (in this example, the median compensation of an existing population attribute). The second value attribute corresponds to the variation between the compensation as value brought attribute 514 and the median compensation of an existing population attribute. Thus, the compensation optimization engine 110 calculates the percentage difference of the variation between the compensation as value brought attribute 514 and the median compensation of an existing population attribute, as a percentage of the median compensation of an existing population attribute. Thus, a positive percentage indicates that the compensation as value brought attribute 514 is higher than the median compensation of an existing population attribute by that percentage of the median compensation of the existing population.

At step 240c, the compensation optimization engine 110 derives the third value attribute 730 based on the value-brought attribute (the compensation as value brought attribute 514) and the second position attribute (the budgeted cost attribute). The third value attribute 730 corresponds to a wage optimization, and is generated by the compensation optimization engine 110 by calculating the difference between the budgeted cost attribute and the compensation as value brought attribute 514. The third value attribute 730 can include a numerical value indicating the amount of difference, whereby a positive amount represents an amount where the compensation as value brought attribute 514 is lower than the budgeted cost attribute. The third value attribute 730 can also include a percentage difference corresponding to the calculated difference as a percentage of the budgeted cost attribute.

At step 250, the compensation optimization engine generates a variation optimization data object as a function of the value-brought attribute(s) used in step 240 (in this example, the compensation as value brought attribute 514), the candidate attribute(s) (in this example, the existing compensation attribute 313), the first position attribute (in this example, the median compensation of an existing population attribute) and, optionally, the second position attribute (in this example, the budgeted cost attribute).

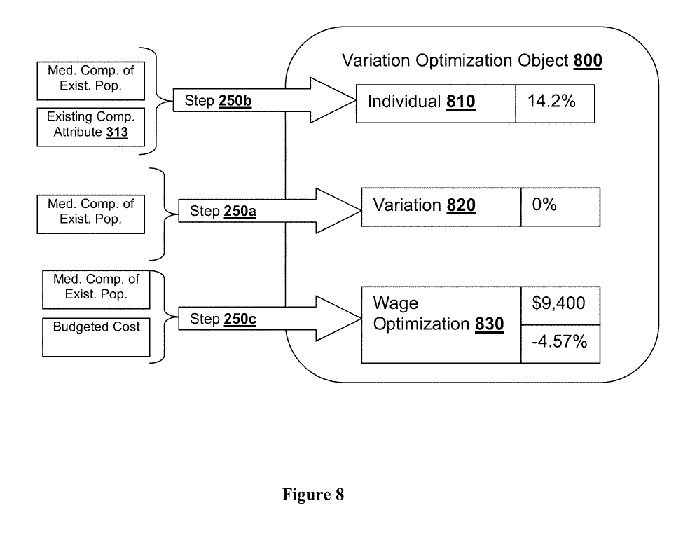

As shown in FIG. 8, a variation optimization object 800 includes a first variation attribute 810 (corresponding to the first constituency, i.e. the individual candidate), a second variation attribute 820 (corresponding to the second constituency, i.e. the variation), and a third variation attribute 830 (corresponding to the third constituency, i.e. wage optimization). The variation optimization object 800 represents the effects of a potential offer to the candidate if the offer is in line with the median compensation of the group or population within the organization (represented by the median compensation of an existing population attribute of the position object). Thus, the analysis for the variation optimization object 800 is performed by constraining the variation (represented by the second variation attribute 820) to 0%. FIG. 8 provides an illustration of the processes of step 250 in further detail.

At step 250a, the compensation optimization engine 110 sets the second variation attribute to 0%. In embodiments, the compensation optimization engine 110 can create a copy of the compensation as per value brought attribute 514 for use in the generation of the variation optimization object 800 and set the copy to have a value equal to that of the median compensation of existing population attribute, and then calculate the value of the second variation attribute 820. Thus, in these embodiments, the compensation optimization engine 110 generates the second variation attribute 820 based on the first position attribute and the copy of the value-brought attribute. Because the values are the same, the variation will still equal 0%. In these embodiments, however, variations can be calculated between different populations within the organization by importing additional median compensation of existing population attributes corresponding to other groups (e.g., subsets of the population of the first group used, other groups, departments, etc.).

At step 250b, the compensation optimization engine 110 derives the first variation attribute 810 based on the first position attribute and the candidate attribute. In the illustrated example, the first variation attribute 810 is the difference between the median compensation of the existing population and the existing compensation attribute 313 expressed as a percentage.

At step 250c, the compensation engine derives the third variation attribute 830 based on the first position attribute and the second position attribute. The first position attribute used to generate is the median compensation of an existing population attribute which, as previously discussed, corresponds to a calculated median compensation of a designated population within the organization (e.g., a department, segment of employees, etc.). The second position attribute is the budgeted cost attribute. The third variation attribute 830 corresponds to a wage optimization for a second variation attribute 820 value of 0%, and is generated by the compensation optimization engine 110 by calculating the difference between the budgeted cost attribute and the median compensation of existing population attribute. The third variation attribute 830 can include a numerical value indicating the amount of difference, whereby a positive amount represents an amount where the median compensation of existing population attribute is lower than the budgeted cost attribute. The third variation attribute 830 can also include a percentage difference corresponding to the calculated difference as a percentage of the budgeted cost attribute.

At step 260, the compensation optimization engine 110 executes a spectrum algorithm to generate a final optimization object as a function of the candidate attribute, the at least one first position attribute and the at least one second position attribute. The spectrum algorithm can comprise computer-executable instructions that can serve to program the compensation optimization engine 110 to generate the final optimization object according to the instructions of the spectrum algorithm. Thus, the spectrum algorithm can comprise a modular section of the compensation optimization engine 110, an application executable by the compensation optimization engine 110, an add-on to the compensation optimization engine 110, an executable software predicate that can be appended to the compensation optimization engine 110, etc.

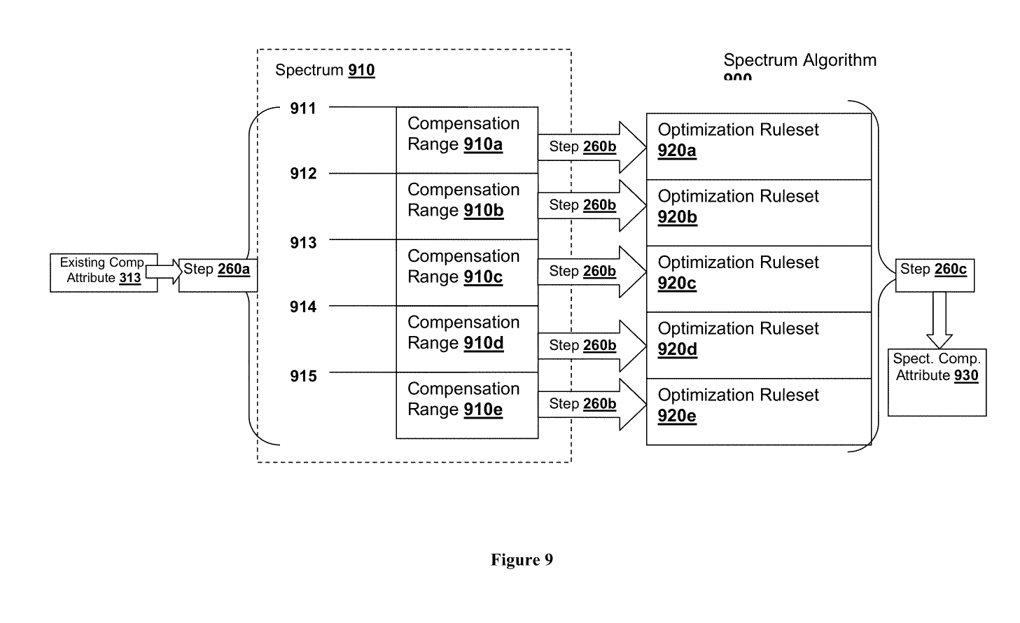

FIG. 9 illustrates the execution of spectrum algorithm 900 to carry out step 260 in greater detail. As illustrated in FIG. 9, the spectrum algorithm 900 includes a compensation spectrum 910 that comprises a plurality of compensation ranges 910a, 910b, 910c, 910d and 910e, ranked from highest to lowest. The boundaries 911, 912, 913, 914 and 915 define the ranges of compensation ranges 910a, 910b, 910c, 910d and 910e, respectively, and correspond to various compensation thresholds used to dictate how to calculate potential compensation values for the candidate. The boundaries 911, 912, 913, 914 and 915 (and therefore, the compensation ranges 910a, 910b, 910c, 910d and 910e) can be based on various position attributes of the position object 121 associated with the position, as used in the illustrative example of FIG. 9.

Boundary 911 corresponds to the maximum compensation level that the organization is willing (or able) to offer. In embodiments such as the example of FIG. 9, the maximum compensation level boundary 911 can directly correspond to the maximum compensation attribute 121f of position object 121. In these embodiments, the maximum compensation attribute of position object 121 can correspond to a 20% increase over the market median attribute of the position object 121, and thus the value calculated as a part of the regular updates to the position object 121 within the position database 120. Thus, in this example, the maximum compensation attribute 121f is $252,000. This current, pre-calculated value for the maximum compensation attribute 121f is thereby directly incorporated into the maximum compensation. In embodiments, the maximum compensation level boundary 911 is determined by calculating an increase above the median market attribute of position object 121 (for example, 20%).

In other embodiments, the maximum compensation attribute of position object 121 can be set by the organization manually via user interface 130, and this value is used as the value for the maximum compensation boundary 911. In still other embodiments, the maximum compensation level can be set to correspond to the budgeted cost attribute 121a of position object 121.

Boundary 912 corresponds to the market median attribute 121c of position object 121 (in the illustrative example, “$210,000”). Thus, compensation range 910a is the range between the market median attribute value 912 and the maximum compensation level 911, inclusive of boundary 912. Boundaries 913 and 914 correspond to the median compensation of existing population attribute 121d (in this example, “$205,600”) and the minimum compensation attribute 121e (in this example, $168,000) of the position object 121, respectively. As such, compensation range 910b is the range between the market median attribute value (boundary 912) and the median compensation of existing population attribute (boundary 913) inclusive of boundary 913, and compensation range 910c is the range between the median compensation of existing population attribute (boundary 913) and the minimum compensation attribute (boundary 914), inclusive of boundary 914. Boundary 915 corresponds to a percentage below the minimum compensation attribute of the position object 121 (in this example, 20% below the minimum compensation attribute). Compensation range 910b is the range between the minimum compensation attribute (boundary 914) and the compensation level set by boundary 915 (again, in this example, 20% below the minimum compensation attribute), inclusive of boundary 915. Compensation range 910e corresponds to any compensation values below boundary 915.

The spectrum algorithm 900 includes a plurality of optimization rulesets 920a-920e, each of the plurality of optimization rulesets associated with a respective compensation range 910a-910e within the compensation spectrum 910. The optimization rulesets 920a-920e contain the rules and instructions that the compensation optimization engine 110 uses to generate a spectrum compensation attribute 930 indicating the maximum compensation level for the candidate, which is to be used in generating the final optimization object. In the example illustrated in FIG. 9, the rules and instructions within each optimization ruleset are as follows:

In invoking optimization ruleset 920a, the compensation optimization engine 110 first imports the compensation as per value-brought attribute 514. Then, the compensation optimization engine 110 generates a spectrum compensation attribute 930 having a value that is calculated by capping the maximum compensation to the minimum of either (a) a 20% increase to the value of existing compensation attribute 313 or (b) the maximum compensation amount indicated by boundary 911.

In invoking optimization ruleset 920b, the compensation optimization engine 110 first imports the compensation as per value-brought attribute 514. The compensation optimization engine 110 then generates the candidate maximum compensation attribute 930 by first comparing the value-brought attribute 514 and the market median attribute (also the value of boundary 912) to determine which is less. Second, the compensation optimization engine 110 then compares (a) the value of the lesser of the value-brought attribute 514 and (b) the market median attribute and a 20% increase to the value of existing compensation attribute 313. Finally, compensation optimization engine 110 then populates the spectrum compensation attribute 930 with the lesser value of this second comparison.

In embodiments, the compensation optimization engine 110 can be set to populate the spectrum compensation attribute 930 with the greater of the two values.

In invoking optimization ruleset 920c, the compensation optimization engine 110 first imports the compensation as per value-brought attribute 514. The compensation optimization engine 110 then compares the compensation as per value-brought attribute 514 with the median compensation of an existing population attribute 121d. If the compensation as per value-brought attribute 514 is greater or equal to the median compensation of an existing population attribute 121d, then the compensation optimization engine 110 compares (a) the median compensation of an existing population 121d and (b) a 20% increase to the value of existing compensation attribute 313. Finally, compensation optimization engine 110 then generates the spectrum compensation attribute 930 populated with the lesser value of this second comparison. If the compensation as per value-brought attribute 514 is less than the median compensation of an existing population attribute 121d, then the spectrum compensation attribute 930 is generated to equal the existing compensation attribute 313.

In embodiments, optimization ruleset 920c can include a rule that if the compensation as per value-brought attribute 514 is less than the median compensation of an existing population attribute 121d, the spectrum compensation attribute 930 is generated having a value of the lesser of (a) an increase of half of the compensation increment attribute 121b to the existing compensation attribute 313 and (b) the midpoint between the existing compensation attribute 313 and the median compensation of an existing population attribute 121d.

In invoking optimization ruleset 920d, the compensation optimization engine 110 first imports the compensation as per value-brought attribute 514. The compensation optimization engine 110 then compares the compensation as per value-brought attribute 514 with the median compensation of an existing population attribute 121d. If the compensation as per value-brought attribute 514 is greater or equal to the median compensation of an existing population attribute 121d, then the compensation optimization engine 110 compares (a) the median compensation of an existing population 121d and (b) a 20% increase to the value of existing compensation attribute 313. Finally, compensation optimization engine 110 then generates the spectrum compensation attribute 930 populated with the lesser value of this second comparison. If the compensation as per value-brought attribute 514 is less than the median compensation of an existing population attribute 121d, then the spectrum compensation attribute 930 is generated to equal the existing compensation attribute 313.

In embodiments, optimization ruleset 920d can include a rule that if the compensation as per value-brought attribute 514 is less than the median compensation of an existing population attribute 121d, the spectrum compensation attribute 930 is generated to equal the minimum compensation attribute 121e.

In embodiments, the compensation optimization engine 110 can first adjust the compensation as per value brought attribute 514 by decreasing it by a set amount (3% is preferred, but other values between 0-10% such as 5%, 7% or 10% are contemplated). This adjusted compensation as per value brought attribute 514 is then used in the processes of the optimization rulesets 920a-920d. In a variation of these embodiments, the adjustment can be performed only if the compensation as per value brought attribute 514 is greater than the corresponding spectrum boundary value for each of the optimization rulesets 920a-920d. For example, for ruleset 920c, the compensation as per value brought attribute 514 is only decreased if the compensation as per value brought attribute 514 is greater than the median compensation of an existing population attribute 121d.

In embodiments, the amount of increase to the value of the existing compensation attribute 313 can be lower than 20%. Other contemplated increase values can be between 0-19%, such as 11%, 12%, etc.

In a variation of optimization ruleset 920c for embodiments whereby the compensation as per value brought attribute 514 is adjusted, the compensation optimization engine 110 can, if the (pre-adjustment) compensation as per value-brought attribute 514 is greater than the median compensation of an existing population attribute 121d, compare the adjusted compensation as per value-brought attribute to the increased existing compensation attribute 313 (in these embodiments, an increase of less than 20%, and more preferably less than 15%, such as 11%, 12% etc.) and generate the spectrum compensation attribute 930 to equal the greater of these two values, without exceeding a 20% of the existing compensation attribute 313.

In invoking optimization ruleset 920e, the compensation optimization engine 110 simply generates the candidate maximum compensation attribute such that its value matches the minimum compensation offer level of boundary 914, thus ensuring that the spectrum compensation attribute 930 includes a raise of at least 20% for the candidate from their existing compensation (i.e. the existing compensation attribute 313).

It should be noted that, for the descriptions of the functions and processes associated with step 260 described in further detail herein, it is assumed that the compensation optimization engine 110 is executing according to the instructions of spectrum algorithm 900.

The compensation optimization engine 110 can select an optimization ruleset from the available plurality of optimization rulesets based on the candidate attribute (in this example, the existing compensation attribute 313) and the plurality of compensation ranges within the compensation spectrum 910. At step 260a, the compensation optimization engine 110 determines which compensation range 910a-910e is the range within which the existing compensation attribute 313 falls.

In the current example, the candidate's existing compensation is $180,000. Thus, the compensation optimization engine 110 selects compensation range 910c (between $210,000 and $168,000) at step 260a.

At step 260b, the compensation optimization engine 110 invokes the corresponding ruleset. In the present example, the compensation optimization engine invokes optimization ruleset 920c associated with the compensation range 910c selected in step 260a. Having selected the optimization ruleset, the compensation optimization engine can then generate a spectrum compensation attribute 930 as a function of the selected rule set and one or more of the value-brought attribute(s), the candidate attribute(s), the first position attribute(s) and the second position attribute(s) at step 260c.

Executing the optimization ruleset 920c described above, the compensation optimization engine 110 compares the compensation as per value-brought attribute 514 ($206,388) with the median compensation of an existing population attribute 121d ($205,600) to determine which is the lesser of the two. Upon determining that the median compensation of an existing population attribute 121d is lesser, the compensation optimization engine 110 then compares the median compensation of an existing population 121d ($205,600) and a 20% increase to the value of existing compensation attribute 313 ($216,000). Finally, compensation optimization engine 110 generates the spectrum compensation attribute 930 populated with the lesser value of this second comparison, in this case $205,600.

It should be noted that the optimization rulesets 920a-920e can be stored locally with the rest of the spectrum algorithm 900 (e.g., stored in the same memory device, in the same computing device, integrated into a unitary software module or application that includes the rulesets, etc.), or can be stored remotely in a rulesets database (e.g., a memory device, a remote server, cloud storage, etc.) accessible by the compensation optimization engine 110 via a network, and retrieved by the compensation optimization engine 110 from the rulesets database as needed to execute the functions of step 260. Thus, to save local storage and preserve network resources, in embodiments the compensation optimization engine 110 can be programmed retrieve only the optimization ruleset corresponding to the compensation range determined at step 260a, thus negating the need to transmit all of the optimization rulesets to local storage and/or store all of the optimization rulesets locally at all times.

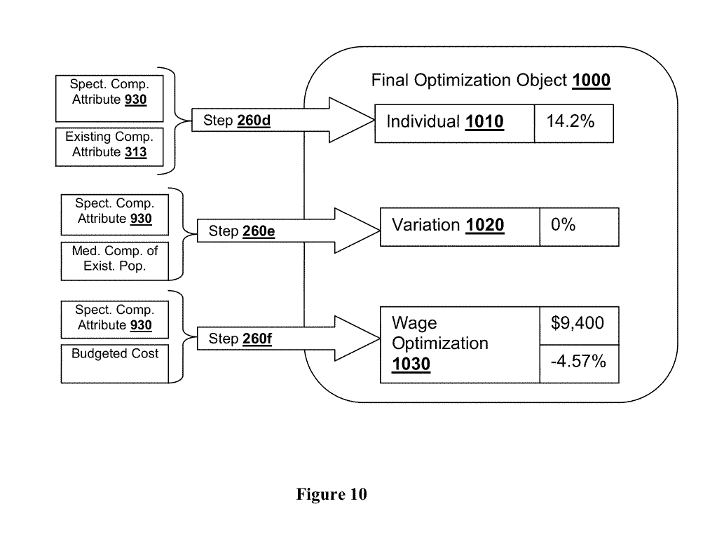

The final optimization object can be generated by the compensation optimization engine as a function of the spectrum compensation attribute 930, the candidate attribute, the first position attribute, and the second position attribute. FIG. 10 illustrates the generation of final optimization object 1000 can include a first spectrum attribute 1010 (corresponding to the first constituency), a second spectrum attribute 1020 (corresponding to the second constituency), and a third spectrum attribute 1030 (corresponding to the third constituency).

At step 260d, the compensation optimization engine 110 derives the first spectrum attribute 1010 based on the spectrum compensation attribute 930 and the candidate attributes (in this example, the existing compensation attribute 313). The first spectrum attribute 1010 corresponds to a percentage difference between the spectrum compensation attribute 930 (in this example, $205,600) and the existing compensation attribute 313 ($180,000). In this case, the spectrum compensation attribute 930 represents a 14.2% increase from the existing compensation attribute 313.

At step 260e, the compensation optimization engine 110 derives the second spectrum attribute 1020 based on the spectrum compensation attribute 930 and the first position attribute (in this example, the median compensation of an existing population attribute 121d). The second spectrum attribute 1020 corresponds to the variation between the spectrum compensation attribute 930 and the median compensation of an existing population attribute. Thus, the compensation optimization engine 110 calculates the percentage difference of the variation between the spectrum compensation attribute 930 and the median compensation of an existing population attribute, as a percentage of the median compensation of an existing population attribute. Thus, a positive percentage indicates that the spectrum compensation attribute 930 is higher than the median compensation of an existing population attribute by that percentage of the median compensation of the existing population. In this example, because the spectrum compensation attribute 930 has been set to be the same as the median compensation of an existing population attribute 121d by optimization ruleset 920c, the variation is 0%.

At step 260f, the compensation optimization engine 110 derives the third spectrum attribute 1030 based on the spectrum compensation attribute 930 and the second position attribute (the budgeted cost attribute). The third spectrum attribute 1030 corresponds to a wage optimization, and is generated by the compensation optimization engine 110 by calculating the difference between the budgeted cost attribute and the spectrum compensation attribute 930. The third spectrum attribute 1030 can include a numerical value indicating the amount of difference, whereby a positive amount represents an amount where the spectrum compensation attribute 930 is lower than the budgeted cost attribute. The third spectrum attribute 1030 can also include a percentage difference corresponding to the calculated difference as a percentage of the budgeted cost attribute. In this example, the wage optimization represented by the third spectrum attribute 1030 corresponds to an optimization of $9,400 over the budgeted cost, which corresponds to 4.57%.

Thus, the compensation optimization engine 110 can derive the first spectrum attribute 1010 by applying the spectrum algorithm 900, using the candidate attribute (existing compensation attribute 313) and the value-brought attribute (according to the corresponding optimization ruleset selected). The compensation optimization engine 110 can derive the second spectrum attribute 1020 by applying the spectrum algorithm 900, using the first position attribute (the median compensation of an existing population attribute) and the value-brought attribute (according to the corresponding optimization ruleset selected). The compensation optimization engine 110 can derive the third spectrum attribute 1030 by applying the spectrum algorithm 900, using the candidate attribute (existing compensation attribute 313), the second position attribute (the budgeted cost attribute) and the value-brought attribute (according to the corresponding optimization ruleset selected).

Having generated the value-brought optimization object, the variation optimization object, and the final optimization object, the compensation optimization engine 110 instantiates a user offer tool 1100 at step 270 corresponding to the candidate, for use by the authorized organization personnel to generate an offer for the candidate. The user offer tool 1100 can be in the form of an application, a browser add-on, an API, etc. At step 280, the compensation optimization engine 110 presents the instantiated user offer tool 1100 to the user.

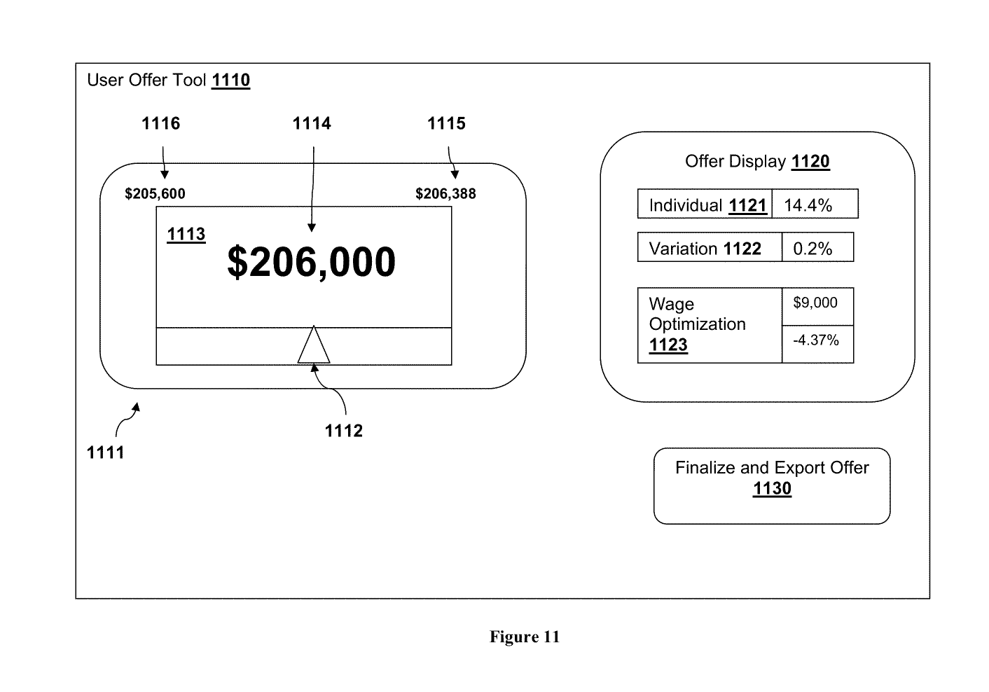

The user offer tool 1100 is an interactive tool that a user (e.g., the authorized organization personnel) can use to adjust an offer amount within a negotiation zone set by the compensation optimization engine 110, and provides feedback of the effects of the changes to an offer level to the user. FIG. 11 provides an illustrative example of a user offer tool 1100. The example of FIG. 11 can be presented to the user via the user interface 130.

The compensation optimization engine 110 instantiates the user offer tool by applying the compensation as value-brought attribute 514 as the first (upper) boundary of the negotiation zone and the spectrum compensation attribute 930 as the second (lower) boundary of the negotiation zone.

As shown in FIG. 11, the user offer tool 1110 can include the generation of a graphical slider tool 1111 that allows the user to set different offer values within the negotiation zone by adjusting the slider 1112 along the negotiation zone 1113. In embodiments, the negotiation zone 1112 can include markers indicating incremental values between each of the boundaries. In other embodiments (such as the one illustrated in FIG. 11), the actual value 1114 corresponding to the position of slider 1112 within the range represented by the negotiation zone 1113 can be shown within the negotiation zone 1113 as the slider 1112 is moved within the negotiation zone 1112. In this example, the slider 1112 is at a position corresponding to an offer of “$206,000”.

As shown in FIG. 11, the upper and lower boundaries 1115,1116 are labeled with the values of the value-brought attribute 514 and the spectrum compensation attribute 930, respectively. Because the boundaries correspond to the compensation as value-brought attribute 514 and the spectrum compensation attribute 930, the user is only allowed to select potential offer values within these ranges.

As shown in FIG. 11, the user offer tool 1110 can also provide a display 1120 that shows, for the offer value corresponding to the position of the slider 1112, the percentage of increase above the current salary that the offer value 1114 represents 1121 (here, a 14.4% increase), the variation 1122 of the currently selected offer value 1114 from the median compensation of an existing population attribute 121d and the wage optimization of the current offer value 1123 (e.g., the difference between the current offer value and the budgeted cost attribute 121a). In embodiments, the display 1120 can also include a display of a difference between the currently selected offer value 1114 and the market median attribute 121c.

It is contemplated that the user offer tool 1110 can include a user-selectable command to export an offer value 1114 to a template to generate an offer letter, such as from an offer letter template generated by the organization, for emailing or printing and presentation to the candidate. FIG. 11 illustrates this via clickable “Finalize and Export Offer” button 1130. However, it is contemplated that the command can be generated and presented via a drop-down menu or other user-interactive form.

In embodiments, the user offer tool 1110 can further include displays of one or more of spectrum compensation attribute 930, the compensation as value brought attribute 514, the minimum compensation attribute 121e, the population median compensation attribute 121d, the market median compensation attribute 121c, and the existing compensation attribute 313.

It is contemplated that some or all of the data used can be encrypted during storage and decrypted for use by the compensation optimization engine 110 to execute processes and functions associated with the inventive subject matter. Further, the compensation optimization engine 110 can encrypt any data outputs it generates for secure storage.

It is contemplated that the compensation optimization engine 110 can be programmed to delete candidate information 300 after executing the processes and functions of the inventive subject matter, such as after the tool 1110 is generated or after the offer value is exported to generate an offer letter in order to conserve storage and computing resources.

In embodiments, the compensation optimization engine 110 is programmed to generate an optimized compensation recommendation based on the spectrum compensation attribute 930, and can cause an output device (e.g., a user's computer, smartphone, laptop, tablet, or other user device used to present information to the user) to present the optimized compensation recommendation to the user.

In these embodiments, the optimized compensation recommendation can include the optimized offer corresponding to the spectrum compensation attribute 930, a value brought offer corresponding to the compensation as value brought attribute 514, and one or more of a minimum compensation 121e, a population median compensation 121d, a market median compensation 121c, and an existing compensation 313.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system comprising:
a position database storing position attributes associated with a particular employment position within an organization;
a compensation optimization engine executed by a processor communicatively coupled to the position database, the compensation optimization engine programmed to:
receive a plurality of candidate attributes associated with a candidate;
generate a value brought object as a function of the candidate attributes, the value brought object comprising value brought attributes;
generate a value brought optimization object as a function of at least one value brought attribute from the value brought object and each of at least one candidate attribute, at least one first position attribute, and at least one second position attribute;
generate a variation optimization object as a function of the at least one first position attribute and each of the at least one candidate attribute, and the at least one second position attribute;
generate a final optimization object by using a spectrum algorithm, as a function of the at least one candidate attribute, the at least one first position attribute, and the at least one second position attribute;
generate a custom user offer tool corresponding to the candidate based on the value brought optimization object and the final optimization object, wherein the custom user offer tool enables a user to select an offer value only within a negotiation zone having a range of offer values determined as a function of the value brought optimization object and the final optimization object; and
cause the user offer tool to be presented to the user via a user interface.

2. The system of claim 1, wherein:
the value brought optimization object includes a first value attribute corresponding to a first constituency, a second value attribute corresponding to a second constituency, and a third value attribute corresponding to a third constituency;
the variation optimization object includes a first variation attribute corresponding to the first constituency, a second variation attribute corresponding to the second constituency, and a third variation attribute corresponding to the third constituency;
the final optimization object includes a first spectrum attribute corresponding to the first constituency, a second spectrum attribute corresponding to the second constituency, and a third spectrum attribute corresponding to the third constituency.

3. The system of claim 2, wherein:
the first value attribute is derived based on the at least one value brought attribute and the at least one candidate attribute;
the second value attribute is derived based on the at least one value brought attribute and the at least one first position attribute; and
the third value attributed is derived based on the at least one value brought attribute and the at least one second position attribute.

4. The system of claim 2, wherein:
the first variation attribute is derived based on the at least one first position attribute and the at least one candidate attribute;
the second variation attribute is derived based on the at least one first position attribute;
the third variation attribute is derived based on the at least one first position attribute and the at least one second position attribute.

5. The system of claim 2, wherein:
the first spectrum attribute is by applying the spectrum algorithm, as a function of the at least one candidate attribute and the value brought attribute;
the second spectrum attribute is derived by applying the spectrum algorithm, as a function of the at least one candidate attribute, the at least one first position attribute and the value brought attribute; and
the third spectrum attribute is derived by applying the spectrum algorithm, as a function of the at least one candidate attribute, the at least one second position attribute and the value brought attribute.

6. The system of claim 2, wherein the compensation optimization engine is further programmed to:
define a first boundary of the negotiation zone using the first value attribute; and
define a second boundary of the negotiation zone using the first spectrum attribute.

7. The system of claim 6, wherein the first boundary corresponds to an upper boundary of the negotiation zone and the second boundary corresponds to a lower boundary of the negotiation zone.

8. The system of claim 1, wherein the spectrum algorithm comprises a plurality of optimization rulesets, each of the plurality of optimization rulesets corresponding to a different compensation range within a compensation spectrum.

9. The system of claim 8, wherein the compensation optimization engine is further configured to:
select an optimization ruleset from the plurality of optimization rulesets based on the at least one candidate attribute and the plurality of compensation ranges within the compensation spectrum;
generate a spectrum compensation attribute as a function of the selected optimization ruleset, and at least one of: the at least one value brought attribute, the at least one candidate attribute, the at least one first position attribute, and the at least one second position attribute;
generate the final optimization object as a function of the spectrum compensation value, the at least one candidate attribute, the at least one first position attribute, and the at least one second position attribute.

10. The system of claim 1, wherein:
the plurality of candidate attributes include at least two of a line of business attribute, a position grade attribute, a prior experience attribute, an existing compensation attribute, at least one related skill attribute, a previous organization attribute, an assessment score attribute, and a special criteria attribute;
the value brought attributes include at least one of a weighted candidate score attribute, a total value brought attribute, a compensation play attribute, a compensation as value brought attribute; and
the position attributes include at least one of a position role attribute, a position task attribute, a position skill attribute, a minimum offer attribute, a maximum offer attribute, a median compensation of an existing population attribute, a market median compensation attribute, and a budgeted cost attribute.

11. The system of claim 10, wherein the weighted candidate score attribute is derived as a function of the assessment score attribute and at least one additional candidate attribute.

10. The system of claim 10, wherein the total value brought attribute is derived as a function of at least one candidate attribute and at least one position attribute.

11. The system of claim 10, wherein the compensation as value brought attributed is derived as a function of the total value brought attribute and at least one position attribute.

12. The system of claim 10, wherein the at least one candidate attribute comprises the existing compensation attribute.

13. The system of claim 10, wherein the at least one value brought attribute comprises the compensation as value brought attribute.

14. The system of claim 10, wherein the at least one first position attribute comprises the median compensation of an existing population attribute.

15. The system of claim 10, wherein the at least one second position attribute comprises the budgeted cost attribute.

16. The system of claim 1, wherein the custom user offer tool comprises a user-adjustable slider within the negotiation zone.
